(19) United States
(12) Patent Application Publication
(10) Pub. No.: US 2021/0197738 A1
(43) Pub. Date: Jul. 1, 2021

(54) InstaTAB

(71) Applicant: Ramon Answar Hameen Johnson Johnson, Saint Louis Park, MN (US)

(72) Inventor: Ramon Answar Hameen Johnson Johnson, Saint Louis Park, MN (US)

(21) Appl. No.: 16/883,896

(22) Filed: May 26, 2020

Related U.S. Application Data
(60) Provisional application No. 62/955,609, filed on Dec. 31, 2019.

(51) Int. Cl. B60R 13/10; H04W 4/80

(52) U.S. Cl. CPC B60R 13/10; H04W 4/80

(57) ABSTRACT

InstaTAB solves the need for the vehicle registration sticker. Consumers use their mobile device to download an appt which updates InstaTAB which is a digital electrical component that adheres to the vehicle license plate or vehicle windshield. The consumer pays on the app to update the vehicle registration via Bluetooth technology. No need to purchase online or take a trip to the DMV.

### BACKGROUND

InstaTAB pertains to the vehicle registration sticker that is purchased yearly by any consumer owning a motor vehicle since 1959. InstaTAB will replace the vehicle registration sticker with a digital, electronic component that will adherer to the license plate in the same position as the sticker or in the same place on your windshield depending on which state you live in.

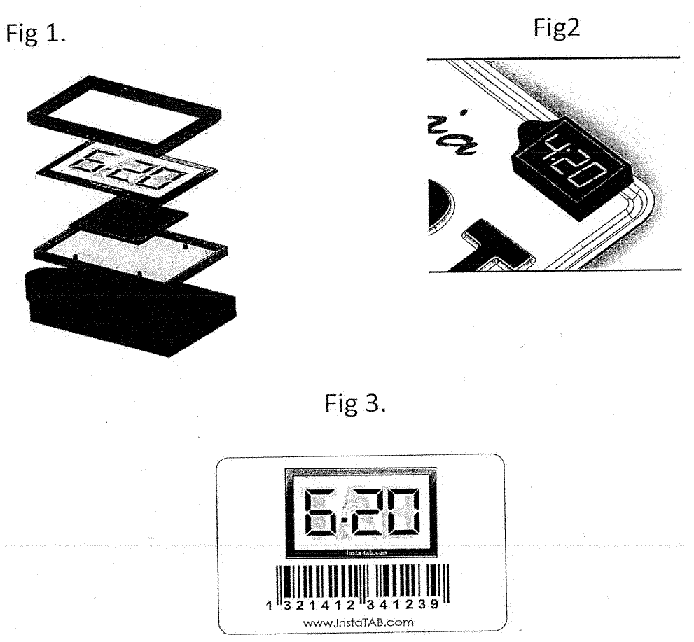

FIG 1. Electronic/digital tab showing front cover, display, bottom housing, and the dock which affixes to the license plate.

FIG 2. Electronic/digital tab display with month/year showing the device attached to the vehicle's license plate. Device can be attached anywhere on the license plate to be in compliance with your state law.

FIG 3. Electronic/digital window tab showing the vehicle registration tab which affixes to your windshield depending on your state's law.

1. This is a digital, electronic vehicle registration component that replaces the need for the vehicle registration sticker. This component adheres to your vehicle license plate or the windshield of your vehicle depending on what state you live in. This component is controlled by the InstaTAB app on your mobile device. This app updates the vehicle registration component to reflect the updated month and year of your vehicle registration tabs.
